(19) United States
(12) Patent Application Publication
(10) Pub. No.: US 2005/0211512 A1
(43) Pub. Date: Sep. 29, 2005

(54) Method for applying a shim

(76) Inventor: Allan Fenwick, Thornhill (CA)

Correspondence Address: Gowling Lafleur Henderson LLP, Suite 4900, Commerce Court West, Toronto, ON, M5L 1J3, CA

(21) Appl. No.: 10/934,470

(22) Filed: Sep. 7, 2004

(30) Foreign Application Priority Data
Mar. 26, 2004 (CA) 2,462,355

(51) Int. Cl. F16D 65/00

(52) U.S. Cl. 188/250 G; 188/73.1

(57) ABSTRACT

A method is provided for attaching a shim to a predefined component in a breaking system. The method comprises the following steps. A liquid shim is applied to the predefined component, the liquid shim comprising a granulated liquid capable of adhering to the predefined component and being resistant to rust. The liquid shim is dried to form a shim attached to the predefined component, the shim capable of dampening vibration.

The present invention relates generally to disc brakes and, specifically to disc brakes have shims attached thereto, and claims priority from Canadian Application No. 2,462,355.

### BACKGROUND OF THE INVENTION

A disc brake pad comprises two main components. The first component is a friction material for contacting a rotor in order to provide braking action for slowing or stopping a vehicle. The second component is a backing plate that supports the friction material. The friction material is attached to the backing plate.

Typically, the friction material is manufactured by processing powders, mixing them and pressing them into various shapes. The shape of the friction material corresponds with shape of the backing plate for facilitating an easy fit when installing the brake in the vehicle. Typically, the backing plates are made of commercial grade metal and get their shape and dimensions from being either mechanically stamped out on a press or being blanked out on a fine flow press. The plate and shape dimensions will be consistent with the die from which they are stamped.

The function material is attached to the backing plate to form the brake pad, which can then be installed in a vehicle. The friction material can be riveted to the plate, glued to the plate or molded onto and into the plate. During the manufacturing process, the friction material and backing plate are molded together creating a one-piece construction.

In a disc brake system, two brake pads are placed into a brake caliper. Generally, a vehicle has two front calipers, although it may also have two rear calipers on occasion. A caliper is a forged metal part that is found in all vehicles and fastened to the vehicle as part of the brake system. The pad and caliper are situated in such a fashion so that the rotor can turn smoothly between the two disc pads.

The rotor is a round component and is made of sintered metal and which is forged into shape. The rotor's size can vary from approximately 2″ to 24″ in diameter and may have a thickness of anywhere from approximately 1/2″ to 6″. Often there are designed air spaces, which are strategically located between the diameter of the two sides of the rotor. The reason for this structure is usually designed to create a lighter weight and enhance cooling.

When the brakes are applied, a hydraulic piston extends and causes the pads to clamp onto the rotor thereby slowing or stopping the vehicle. The caliper supports the brake pads and keeps them in the proper position over the rotor. Any vibration or movement of the pads within the caliper can cause noise which is associated with the braking. The noise emitted will be a groan, squeek, squeal, moan, grind, growl or anything other than silence. There are many causes of noise other than the brake pads. However, any noise which can be detected is almost always blamed on the brake pad.

Accordingly, in order to reduce or stop the vibration of the disc brake within the caliper, some brake manufacturers and resellers have begun attaching shims to the backing plates. Often, a shim is attached to the back surface of each plate, which is supposed to prevent or reduce the possibility of noise when the brakes are applied. These shims are usually constructed of layered material which may include rubber, resins, fiberglass, Kevlar, special low vibration metals, and the like. Their composition is designed to have a dampening effect on the noise being produced by friction alone, as well as the other brake component related vibratory contributions. The shims can be glued on, riveted on, or snapped onto the steel plate. The shape of the shim usually mimics the shape of the steel plate.

However, application of the shims increases the cost of the manufacturing process. Each of the shims has to be purchased or manufactured to specification so that it properly fits the brake pad. Further, the process of attaching die shim by gluing, riveting or snapping-on is time consuming and, accordingly, may slow the brake pad production process. Yet further, depending on how the shim is attached, it may become loose and either fall off the brake pad or create more noise due to vibration.

Thus, it can be seen that there is a need for a more a shim that can be added to a brake pad more efficiently and cheaper than traditional shims, while also reducing the effects of vibrations in a vehicle's brake system.

### SUMMARY OF THE ON

In accordance with an aspect of the present invention, there is provided a method for attaching a shim to a predefined component in a braking system comprising the steps of: applying a liquid shim to the predefined component, the liquid shi comprising A granulated liquid capable of adhering to the predefined component and being resistant to rust; and drying the liquid shim to form a shim attached to the predefined component, the shim capable of dampening vibration

### BRIEF DESCRIPTION OF THE DRAWINGS

An embodiment of the present invention will now be described by way of example only with reference to the following drawings in which:

FIG. 1 is a cross-sectional view of a brake pad with a fine granular shim;

FIG. 2 is a cross-sectional view of a brake pad with a coarse granular shim.

### DETAILED DESCRIPTION OF THE PREFERRED EMBODIMENT

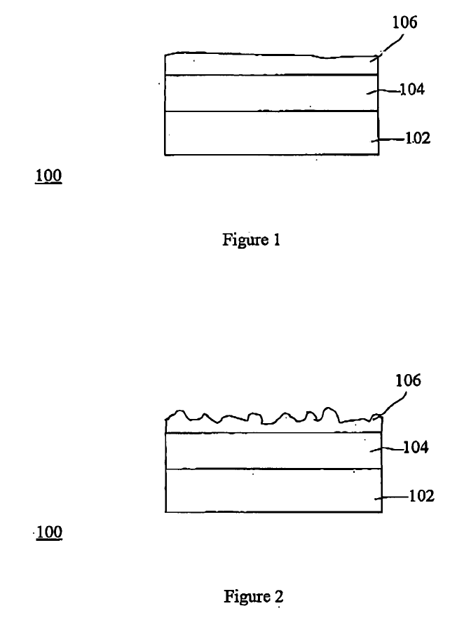

For convenience, like numerals in the description refer to like structures in the drawings. Referring to both FIGS. 1 and 2 a brake pad is illustrated generally by numeral 100. The brake pad 100 includes a friction material 102, a backing plate 104 and a shim 106. In accordance with an embodiment of the present invention, the shim 106 is formed by the application of a liquid shim to the brake pad, which has then dried. The liquid shim can be applied to the brake pad by spraying, direct application or other method that may be known in the art.

Typically, if the liquid shim is applied to the brake pad by spraying, the liquid is delivered through a nozzle attached to a spray gun. Air or electric force is used to deliver the spray If the liquid shim is applied to the brake pad by direct application, the liquid shim may be brushed on or rolled on. Rolling is often preferred to brushing for mass application as it simpler to implement on a production line. For example, the brake pads may be placed on a conveyor belt that pass them over, or under, a series of rollers. The rollers are saturated with the liquid shim and apply the liquid shim to the brake pads as they pass. Once the liquid shim has been applied it is allowed to dry. This process can be achieved by air drying the brake pad or by passing the brake pads through a drying device such as an oven or an air blower.

Wile it will be appreciated by a person of ordinary skill in the art that the properties of the liquid shim may vary, it is preferable that the liquid shim have similar properties to that of standard shims known in the art. That is the shim should be capable of dampening vibration and resistant to rust to promote effective use and a longer product lifetime.

In order to effectively dampen the noise, the liquid shim is typically granular. The granularity of the liquid shim may range from fine to coarse. At one end of the spectrum the texture of the liquid shim may be so fine that it is virtually undetectable, as shown in FIG. 1. Alternately, the texture may be so coarse that it is readily visible, as shown in FIG. 2.

Further, the liquid shim must be capable of adhering to the brake plate, typically the steel portion, so that no additional attachment means are necessary.

Accordingly, the addition of the shim 106 will add a friction surface to the backing plate where it is in contact with the caliper, thereby reducing movement and vibration. The thickness of the shim may be controlled by the application process, and one skilled in the art will appreciate that the desired thickness varies in accordance with the space available for the shim.

In one example, a textured paint referred to as AS-150 and manufactured by American Safety Technologies Inc. was applied as a liquid shim to the brake pad. AS-150 is primarily used as a non-slip floor and deck coating. A material safety data sheet detailing the composition of AS-150 is available from American Safety Technologies Inc. One of the features of AS-150 that make it attractive for use as a liquid shim is that it comprises includes an Alumino-silicate and Aluminum oxide aggregate that provides the granulation in the liquid. Another attractive feature of AS-150 is that it comprises an epoxy. Epoxies are known as generally having good properties for adhesion to steel and for acting as a rust inhibitor. In this particular example, the epoxy is an Epoxy Ester Resin.

In accordance with the present embodiment, the liquid shim is applied to the backing plate after the backing plate has been attached to the friction material. In accordance with an alternate embodiment the liquid shim is applied to the backing plate before the backing plate is attached to the friction material In this embodiment it is preferable to wait until the liquid shim has dried before applying the friction material, although this need not necessarily be the case.

In accordance with yet another embodiment of the invention, the liquid shim may be applied in addition to a standard paint, rust prevention solution other coating for enhancing the appearance and longevity of the brake. The paint is typically black, but may be any another available colour. Accordingly, the brake pad is constructed by attaching the backing plate to the frictional material. The standard paint or other solution is then applied to the brake pad for either enhancing the appearance or longevity of the brake pad. The liquid shim is then applied to the brake pad and dried.

In accordance with yet an alternate embodiment of the present invention, the shim may be applied to the hydraulic piston instead of the brake pad.

In accordance with yet an alternate embodiment of the present invention it may be possible to apply a powder shim using powder painting techniques that are known in the art Typically, the process of powder painting is performed as follows: A coating material, in this case the shim material, is a finely granulated, dry solid powder. The shim material is applied electrostatically to a surface, either the brake pad or the piston. The static charge provides an adhesive force for the dry particles. Heat is applied which causes the particles to melt. The individual particles fuse together to form a continuous fluid layer, which in this case would be the liquid shim. Additional heat initiates a chemical cure reaction which forms a solid film.

It will be appreciated by a person of ordinary skill in the art that the previous descriptions are of preferred embodiments for implementing the invention, and the scope of the invention should not necessarily be limited by this description. Those of skill in the art may effect alterations, modifications and variations to the particular embodiments without departing from the scope of the application. The invention described herein is defined by the claim attached hereto and intend to cover and embrace all suitable changes in technology.

1) A method for attaching a shim to a predefined component in a braking system comprising the steps of:
a) applying a liquid shim to the predefined component, the liquid shim comprising a granulated liquid capable of adhering to the predefined component and being resistant to rust; and
b) drying the liquid shim to form a shin attached to the predefined component, the shim capable of dampening vibration.

2) The method as defined in claim 1, wherein the predefined component is a backing plate of a brake pad.

3) The method as defined in claim 1, wherein the predefined component is a piston for contacting a brake pad.

4) A method as defined in claim 1, wherein the liquid shim is applied by spraying the liquid shim on the predefined component.

5) A method as defined in claim 1, wherein the liquid shim is applied by brushing the liquid shim on the predefined component

6) A method as defined in claim 1, wherein the liquid shim is applied by rolling the liquid shim on the predefined component,

7) A method as defined in claim 1, wherein the liquid shim is applied by powder painting the predefined component.

8) A method as defined in claim 2, flier comprising the step of attaching the backing plate to a friction material after applying the liquid shim.

9) A method as defined in claim 2, further comprising the step of attaching the backing plate to a friction material before applying the liquid shim.

10) A method as defined in claim 9, further comprising the step of applying a standard paint to the brake pad before applying the liquid shim

11) A method as defined in claim 1, wherein the liquid shim comprises an epoxy for adhering to the predefined component and inhibiting rust

12) A method as defined in claim 1, wherein the liquid shim comprises a silica aggregate for enabling the shim to dampen vibration

13) A method as defined in claim 1, wherein the liquid shim comprises an Aluminum Oxide aggregate for enabling the shim to dampen vibration.

14) A method as defined in claim 1, wherein the granulation is fine.

15) A method as defined in claim 1, wherein the granulation is coarse.

16) A brake pad including a shim manufactured using the method of claim 2.

17) A piston for contacting a brake pad manufactured using the method of claim 3.
